(19) United States
(12) Patent Application Publication
(10) Pub. No.: US 2024/0288007 A1
(43) Pub. Date: Aug. 29, 2024

(54) FILTER DEVICE AND PUMP DEVICE THEREWITH

(71) Applicant: Herborner Pumpentechnik GmbH & Co KG, Herborn (DE)

(72) Inventor: Sascha KORUPP, Asslar-Werdorf (DE)

(21) Appl. No.: 18/697,326

(22) PCT Filed: Oct. 12, 2022
(86) PCT No.: PCT/EP2022/078435

§ 371 Date: Mar. 29, 2024

(30) Foreign Application Priority Data
Oct. 12, 2021 (DE) 20 2021 105 521.9

(51) Int. Cl. F04D 29/70; B01D 29/35; B01D 29/66

(52) U.S. Cl. CPC F04D 29/708; B01D 29/35; B01D 29/66

(57) ABSTRACT

A filter device having a filter housing in which a filter cage having through-holes is arranged. A filter inlet of the housing opens into an interior of the filter cage. A filter outlet of the housing leads away from an outer side of the filter cage. The filter cage has a discharge opening, which opens into a discharge opening of the housing, wherein the interior of the filter cage is flow-connected via the discharge openings to a discharge line, which has a discharge shutoff unit, so that fluid can be discharged from the interior of the filter cage via the discharge line when the discharge shutoff unit is actuated. The filter device is part of a pump device having a feed pump, which is arranged between suction and pressure lines, wherein the filter cage of the filter device is arranged in the suction line.

The invention relates to a filter device as claimed in claim 1, and to a pump device therewith as claimed in claim 28.

Pump devices which convey waste water such as, for example, bathing water pumps, usually have a preliminary filter. This filter device ahead of the impeller of a pump is intended to retain coarse contaminations and in this way protect the pump per se, and other line sections downstream of the pump and devices disposed therein, from damage and blockage.

Such filter devices disposed upstream of the pump have to be cleaned regularly, for example at least once per day in the bathing operation of swimming pools. In many instances more frequently in the case of open-air pools. For this purpose, the service water line has to be completely emptied in a section in which the filter device is located. The filter housing can be opened, and the filter basket, or filter mesh, located therein can be removed for cleaning, only thereafter.

Emptying parts of the line connected to the pump, including the filter housing, to be performed prior to the actual cleaning of the filter basket, requires a large amount of time, and water and the thermal energy and water chemical stored thereof are lost.

For more efficient cleaning of a preliminary filter, EP 2 787 149 B1 proposes a device for pneumatically emptying a service water line having a pump, wherein the pump is part of a bathing water circuit, and a preliminary filter is disposed ahead of said pump. A gate valve is disposed ahead of the preliminary filter, and a further gate valve is disposed behind the pump, so as to interrupt the bathing water circuit. Additionally, a compressed air source is connected by way of a controllable valve, and an injection apparatus to the service water line in the region between the gate valves. By injecting air into this blocked region, the fluid trapped between the gate valves can be forced out by way of a discharging apparatus with a controllable valve. A cover of the preliminary filter is subsequently manually opened, the filter basket is removed, cleaned and inserted again. It has proven disadvantageous here that manual work also has to be performed, during which a pool attendant cannot monitor the swimmers, for example.

Therefore, the invention is based on the object of overcoming this and further disadvantages of the prior art, and to provide a solution which makes it possible to clean a filter device in a rapid, cost-effective and efficient manner.

Main features of the invention are set forth in claims 1 and 28. Design embodiments are the subject matter of claims 2 to 27, and 29 to 45.

The invention relates to a filter device having a filter housing in which is disposed a filter basket, or a filter mesh, having passage holes, wherein a filter inlet of the filter housing opens into an interior of the filter basket, and a filter outlet of the filter housing leads away from an outside of the filter basket. It is provided herein that the filter basket has a discharge opening which opens into a discharge opening of the filter housing, wherein the interior of the filter basket, by way of these discharge openings, is fluidically connected to a discharge line, and wherein a discharge shut-off unit is disposed in the discharge line so that a fluid (gaseous or liquid) from the interior of the filter basket is able to be discharged by way of the discharge line by activating the discharge shut-off unit.

With the aid of the discharge openings it is now no longer necessary to open the filter housing and to retrieve the filter basket for cleaning. Instead, filter contamination which has been retained by the filter basket can be discharged from the interior of the filter basket. Discharged fluid entrains the filter contamination. The discharge shut-off unit for its activation is preferably electrically activated. The discharge opening, the filter inlet and the filter outlet should in each case be different openings in the filter housing.

Shut-off units in the context of this document are all components or functional groups for blocking or controlling the flow rate of fluids (liquids or gases). In other words, all of these are devices by way of which a volumetric flow in a line can be reduced or stopped. This includes, inter alia, gate valves, flat slides, piston slides, shut-off flaps, annular flaps, shut-off taps, three-way rotary valves, ball cocks, valves, angle valves, straight seat valves, membrane valves, flaps, slides, gates, throttles, magnetic valves, etc.

According to a more particular design embodiment of the filter device, the filter inlet and the discharge openings are disposed on mutually opposite end regions of the filter basket. In this way, the filter basket can be purged so as to proceed from the inlet toward the discharge opening.

The discharge opening is preferably a hole in a circumferential wall of the filter basket. This permits, for example, visual checking of the contamination by way of an inspection glass on the side of the basket opening.

The filter basket can be disposed so as to be geodetically vertical. In this instance, the filter inlet is preferably at the top, and the discharge opening is at the lower end of the filter basket. In this way, contamination accumulates in the region of the discharge opening in the interior of the filter basket, and is easy to purge. The filter outlet can lead laterally away from the filter basket.

In a particular design embodiment, the filter basket is aligned so as to be geodetically horizontal. As a result, the filter device is able to be combined in a more compact manner with vertically installed pumps, in particular be able to be disposed below such a pump.

Optionally, the filter basket may not have any passage holes in a region disposed geodetically at the bottom. Filter contamination which has been deposited here can be easily purged from the interior, at least also in sections in the horizontal direction. In the lower region, the filter basket acts in particular like a channel base in which nothing can catch in particular. The discharge opening Is preferably formed in the region, disposed geodetically at the bottom, of the filter basket, in which no passage holes are formed. As a result, the contamination can be purged along this region to the discharge opening.

A design embodiment according to which the discharge openings are disposed so as to be co-aligned is expedient for an ideally obstacle-free discharge. This results in a direct, straight path from the interior of the filter basket into the discharge line.

The discharge openings are preferably aligned so as to be geodetically downward. The Earth's gravity thus assists the accumulation of filter contamination in the region of the discharge opening, and the exiting of the interior through the discharge openings, as a result of which a small amount of fluid is required for discharging the filter contamination. An embodiment according to which the discharge line is disposed so as to be geodetically on the bottom on the discharge opening of the filter housing can also contribute to this.

A directing element can optionally be disposed in the filter basket, said directing element being in particular designed in such a manner that it guides fluid and/or contaminants in the direction of the discharge opening. In the absence of such a directing element, contaminants may back up, depending on the design embodiment, this being prevented by the deflection on the directing element. The directing element can be embodied as a metallic (e.g. rolled, edge-bent) component, or embodied as an insert (also plastics material).

In a more particular design embodiment, an inlet shut-off unit is disposed in the filter inlet or an inlet line connected thereto. In this way, the inlet can be temporality reduced or closed if required, in particular while discharging the contaminants. The inlet shut-off unit for its activation is preferably electrically activated. In this way, the inlet or any return flow can be throttled or interrupted in an automatically controlled manner by way of the inlet line.

Furthermore, an outlet shut-off unit can optionally be disposed in the filter outlet or an outlet line connected thereto. In this way, the outlet by way of the outlet line can be temporality reduced or closed if required, in particular while discharging the contaminants. The outlet shut-off unit for its activation is preferably electrically activated. In this way, the outlet or any return flow can be throttled or interrupted in an automatically controlled manner by way of the outlet line.

In particular, the fluid, which is discharged from the interior by way of the discharge shut-off unit, (a) can flow from the filter inlet through the interior of the filter basket without passing through the passage holes, and/or (b) flow from the filter outlet through the passage holes into the interior and from there to the discharge line, and/or (c) be any other fluid which has been directed into the filter housing. As a result, there are a plurality of options for releasing filter contaminations and for purging the latter to the discharge line. Reverse purging of the passage holes also cleans the latter in particular. A flow emanating from the inlet line is particularly energetic or strong and suitable for removing large portions of contamination in the filter basket. Discharging the contaminants may also be successful without the fluid to be filtered, or with a small quantity thereof, by introducing any other fluid. Conceivable are, for example, ejecting contaminants with air, or purging with unprepared water, e.g. cold tap water. In this way, chemically prepared and temperature-controlled bathing water is saved when used in the swimming pool, for example.

In a particular embodiment, an injection apparatus opens into the filter housing by way of an injection opening, a fluid from the filter housing being able to be forced into the filter inlet and/or the filter outlet and/or the discharge line by injecting an injection fluid by way of said injection opening. The fluid flows out of the filter housing depending on which line is blocked or released when injecting. In this way, the fluid can also be first steered into the inlet line and/or outlet line, and the evacuated intermediate space can then be, for example, separated therefrom, before the contaminants are discharged. The contaminants can be ejected by further injecting. Alternatively, introducing purging fluid such as cold water would also be conceivable. As long as the pump is disposed below the fluid level of the pump circuit, the injection fluid or the purging fluid can be forced into the discharge opening by opening the inlet line and/or outlet line. In most swimming pools, there is a relatively high water column with correspondingly high pressure available for this purpose, so that the contaminants are effectively forced out of the filter basket.

Optionally, the discharge shut-off unit for its activation, and the injection apparatus for injecting, can be electrically actuated in such a manner that the discharge shut-off unit is opened after or during injection. It is achieved in this way that the interior is forcibly evacuated by the actually filtered fluid, and/or the contaminants are conveyed through the discharge line by the pressure of the injection apparatus after the discharge shut-off unit has been opened. For instance, an optional design embodiment of the filter device provides in particular that the injection apparatus is actuated in such a manner that fluid is first forced out of the filter housing into the filter inlet and/or the filter outlet, preferably into the filter inlet, by injecting the injection fluid before the discharge shut-off unit is opened. In this way, the filter cleaning requires a small volume of the fluid.

The filter device is specifically designed so that the fluid, which is discharged from the interior by way of the discharge shut-off unit,
flows from the filter inlet through the interior of the filter basket without passing through the passage holes, and/or
flows from the filter outlet through the passage holes into the interior and from there to the discharge line, and/or
is injection fluid which has been injected from the injection apparatus into the filter housing.

The efficiency and fluid losses of the cleaning can thus be optimized by adaptations of these cleaning flows, which act differently, to the specific application.

According to a particular design embodiment the injection opening is fluidically disposed between the passage holes of the filter basket and the filter outlet. As a result, the passage holes can be blown out, or forcibly evacuated, in reverse in the direction of the discharge opening, in particular also using abrupt and/or high pressure.

The injection device preferably has a compressor. Injecting is successful automatically in this way.

In a variant of the filter device, the latter has a ventilating apparatus by which air and/or an injection fluid are/is able to be discharged from the filter housing. In this way, a non-self-priming pump can be used, and damage to the pump by dry-running is avoided. The ventilating apparatus can optionally be connected to the filter housing, the filter outlet or the filter inlet. Of these, the filter outlet is preferable, in particular when the filter device is used as the preliminary filter of a pump.

According to one variant, the filter housing is partially formed by an attachment housing, wherein the discharge opening of the filter housing is formed in the attachment housing. It is possible in this way to modify filter devices without a discharge in a simple manner in that the filter cover of said filter devices is replaced by the attachment housing and optionally by a longer filter basket. The discharge is retrofittable in this way.

The attachment housing optionally has an inspection glass by way of which a view into the interior of the filter basket is in particular enabled. Cleaning of the filter basket can thus be initiated, or else manual cleaning can take place, by a visual check.

The attachment housing is advantageously able to be established in a plurality of angular positions in such a manner that the discharge opening is aligned so as to be pointing geodetically downward or sideways. Should the installation situation not permit the alignment downward, an alignment of the discharge opening toward the side can also be implemented in a simple manner as a result.

The filter housing, preferably the attachment housing, preferably has a filter cover through which the filter basket is removable. In this way, the filter basket can also be manually cleaned, which may be necessary at longer intervals, above all when loaded with long fibrous contamination such as hairs.

In particular, the filter inlet can open into the interior of the filter basket on a side of the latter that lies opposite the filter cover. In this way, the fluid flow runs longitudinally through the filter basket and also steers the contamination in this direction when discharged. Potential blockages or lump formations thus make their way to the proximity of the cover, where they can be manually removed in doubt.

In a particular design embodiment it is provided that the filter basket extends in a tubular manner between the filter cover and the filter inlet. In this way, there are no flow obstacles or flow-calming regions in this flow direction.

Furthermore, the filter basket can be configured to be open on both sides, in particular so as to be elongate and/or cylindrical. In this way, said filter basket is readily purgeable by way of the discharge opening during the automatic cleaning procedure, on the one hand, and said filter basket can be manually cleaned from both sides, on the other hand.

The filter basket is optionally composed of in particular stainless steel. The latter is particularly highly durable. However, embodiments of plastics material are also considered.

According to a possible refinement, the filter device is a pump preliminary filter. Here, the filter device can fully exploit the advantages of protection of the conveying pump without loss of output, and in this instance the discharge function can moreover be easily integrated into the pump control.

In a more specific embodiment, the filter device has a measuring installation comprising a pressure sensor for measuring a pressure within the filter housing, and comprising a processor with an algorithm by way of which the degree of contamination of the filter basket is concluded based on the measured pressure. In this way, the optimal point in time for cleaning the filter basket is able to be determined, and the cleaning is optionally also able to be initiated based thereon, in particular in an automated manner.

The invention moreover relates to a pump device having a conveying pump which is disposed between a suction line and a pressure line, and having a filter device as is described above and hereunder, wherein the filter basket of the filter device is disposed in the suction line. As a result, the filter device becomes a pump preliminary filter and protects the conveying pump from contaminants.

The filter inlet of the filter device here should be disposed so as to be fluidically more remote from the conveying pump than the filter outlet.

In one preferred embodiment, the filter housing is directly contiguous to a pump housing of the conveying pump. In this way, short line paths between the filter basket and the conveying pump are achieved, and all components can be easily aligned and set up.

The conveying pump can in particular have a pump housing in which an impeller is disposed. Rotating impellers are particularly suitable for high conveying volumes. Moreover, the conveying pump should have a drive motor by way of which the impeller is driven.

The pump device can optionally have a dry-run protection which automatically deactivates the conveying pump when there is too little liquid fluid in the conveying pump. In this way, the conveying pump is protected against damage due to dry running, this being particularly important in combination with the optional injection apparatus.

In a specific embodiment, an outlet shut-off unit is disposed in the filter outlet or an outlet line, connected thereto, of the filter device, wherein the conveying pump is fluidically disposed between the filter basket and the outlet shut-off unit.

According to a particular design embodiment of the pump device, the conveying pump for its activation is electrically actuated by a control unit, the discharge shut-off unit for its activation is electrically actuated by the control unit, the outlet shut-off unit for its activation is electrically actuated by the control unit, an inlet shut-off unit is disposed in the filter inlet or in an inlet line connected thereto, wherein the inlet shut-off unit for its activation is electrically actuated by the control unit, and an injection apparatus opens into the filter housing by way of an injection opening, a fluid from the filter housing being able to be forced into the filter inlet and/or the filter outlet and/or the discharge line by injecting an injection fluid by way of said injection opening, wherein the injection apparatus for injecting is electrically actuated by the control unit. In this way, several of the components can be activated in a coordinated and central manner by the central control unit, as a result of which automated filter cleaning is achieved in a reliable manner.

This can be implemented in that a filter cleaning algorithm of the control unit is designed in such a manner that, for carrying out filter cleaning, the control unit
first performs an interruption of operation in that said control unit
a. deactivates the conveying pump;
b. closes the outlet shut-off unit; and
c. closes the inlet shut-off unit;
   thereafter a discharge of contamination takes place in that the control unit
d. opens the discharge shut-off unit;
e. activates the injection apparatus for injecting, and/or opens the outlet shut-off unit and/or opens the inlet shut-off unit;
thereafter
f. closes the discharge shut-off unit;
   thereafter operation is resumed in that the control unit
g. opens the outlet shut-off unit;
h. opens the inlet shut-off unit; and
i. re-activates the conveying pump.

In this way, the pump device is prepared for automatic filter cleaning. The steps can also be performed in a sequence deviating to the above formulated sequence within the temporally defined windows.

Optionally, the filter cleaning algorithm of the control unit can be designed in such a manner that, when discharging contamination, the fluid, which is discharged from the interior by way of the discharge shut-off unit, flows proportionally from the filter inlet through the interior of the filter basket without passing through the passage holes, and flows proportionally from the filter outlet through the passage holes into the interior and from there to the discharge line, and is proportionally injection fluid which is injected into the filter housing by the injection apparatus. As a result, the dirt particles can be released and transported away by different flows.

It is furthermore optionally possible that the filter cleaning algorithm of the control unit is designed in such a manner that the control unit when interrupting the operation activates the injection apparatus for injecting, and opens the outlet shut-off unit and/or the inlet shut-off unit at least partially in such a manner that fluid is forced from the filter housing into the filter inlet and/or the filter outlet by the injection of injection fluid. It is achieved in this way that less of the fluid later escapes through the discharge line, but the proportion of the injection fluid in the cleaning is higher.

Alternatively, the pump device can be designed in such a way that the conveying pump for its activation is electrically actuated by a control unit, the discharge shut-off unit for its activation is electrically actuated by the control unit, the outlet shut-off unit for its activation is electrically actuated by the control unit, an inlet shut-off unit is disposed in the filter inlet or an inlet line connected thereto, wherein the inlet shut-off unit for its activation is electrically actuated by the control unit, wherein a filter cleaning algorithm of the control unit is designed in such a manner that, for carrying out filter cleaning, the control unit
first performs an interruption of operation in that said control unit
   a. deactivates the conveying pump;
   b. closes the outlet shut-off unit and/or the inlet shut-off unit;
thereafter performs a discharge of contamination in that the control unit
   c. opens, or allows to be open, the discharge shut-off unit, on the one hand, and the outlet shut-off unit and/or the inlet shut-off unit, so as to allow fluid to flow from the filter inlet, or the filter outlet, to the discharge opening of the filter housing.

As a result, no additional technical equipment is required for injecting a foreign fluid, and the design embodiment is less complex in technical terms. In applications in which the loss of fluid for a purging procedure tends to be less critical, the fluid per se can thus be used for purging.

According to a simple optional implementation, the flow toward the discharge opening (in particular of the fluid) is caused by a geodetic gradient between the filter inlet, or filter outlet, on the one hand, and the discharge line, on the other hand.

In another optional implementation, the flow toward the discharge opening (in particular of the fluid) is caused by a purging pump. A high volumetric purging flow is generated in this way, this in particular also when no geodetic gradient is formed. The purging pump can be disposed in the inlet, outlet or in a parallel strand to one of the latter. When disposed in a parallel strand, the purging pump does not have to be passed through by a flow in the regular filter process, which increases efficiency and avoids contamination of the purging pump.

In a particular embodiment, the filter device has a ventilating apparatus by which air and/or an injection fluid are/is able to be discharged from the filter housing, wherein the ventilating apparatus for activating the ventilation is actuated by the control unit, wherein the filter cleaning algorithm of the control unit is designed in such a manner that, when resuming operation, the ventilating apparatus is first activated until the filter housing is at least substantially filled with fluid, before the control unit re-activates the conveying pump. As a result, the conveying pump is protected against dry running, and conveying pumps which do not sustain dry running can also be used.

In order for the cleaning to be automated, it can optionally be provided that the filter device has a measuring installation comprising a pressure sensor for measuring a pressure within the filter housing, and comprising a processor with an algorithm by which the degree of contamination of the filter basket is concluded based on the measured pressure, wherein the control unit is designed to start the filter cleaning algorithm when a defined degree of contamination is detected. In this way, filter cleaning is initiated in a customized manner in the event of heavy contamination.

Alternatively or additionally, the filter device can have a time program, in particular with defined temporal points or intervals, wherein the control unit starts the filter cleaning algorithm in a manner corresponding to the time program. This is easy to implement, and when optionally combined with the measuring installation can additionally contribute toward cleaning ideally taking place at specific intervals, for example outside visiting peaks of the swimming operation of a swimming pool.

The cleaning times as well as the utilized cleaning flows are preferably continually optimized by the filter cleaning algorithm by means of collecting data such as the cleaning times, the utilized cleaning flows and the pressure in the filter basket before and after cleaning, etc. In this way, artificial intelligence enters the filter cleaning processes. The optimization herein does not have to be limited to the filter device, but may also take place by exchanging data with further filter devices at the same site and/or at other sites.

Optionally, the pump device, conjointly with further pump devices, can be connected in a data-communicating manner to a central database, and operating parameters of the pump device can be continuously or successively adapted based on data analyses of the central database.

It appears to be particularly favorable to detect data centrally and in a cloud-based manner, to evaluate said data in their entirety, and to further optimize the filter cleaning algorithm of the individual filter device based on the high quantity of data.

It goes without saying that all device features can also be used within a method according to the invention, and that such methods are the subject matter of the disclosure. In particular the actuation of components herein can be carried out as method steps.

In particular, the invention relates to a method for operating a filter device as described above and hereunder, in which method at least one of the following steps is performed:
a fluid is discharged from the interior by way of the discharge shut-off unit in that
fluid is allowed to flow from the filter inlet through the interior of the filter basket without passing through the passage holes, and/or
fluid is allowed to flow from the filter outlet through the passage holes into the interior and from there to the discharge line, and/or
any other fluid is directed into the filter housing.

The advantages correspond to those that are described above in the context of the corresponding device features. It goes without saying that the person skilled in the art can enhance this method expediently with all device features according to the claims and/or the description, as this is implicitly included in the disclosure.

Further features, details and advantages of the invention are derived from the wording of the claims, and from the following description of exemplary embodiments by means of the drawings in which:

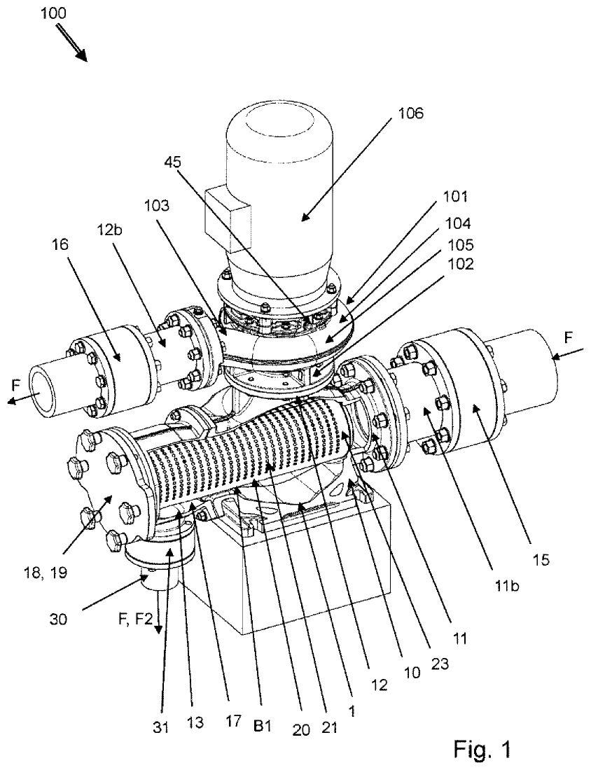

FIG. 1 shows a perspective view of a pump device having a filter device in a partially sectional view;

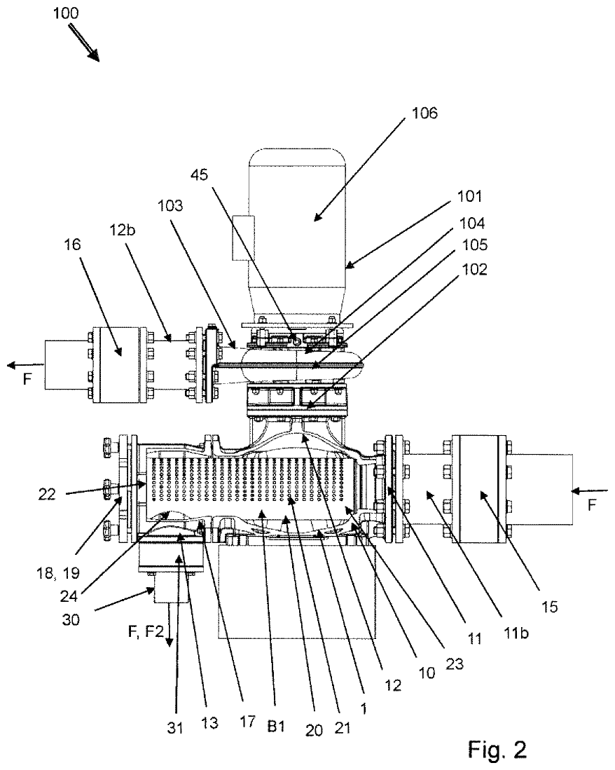

FIG. 2 shows a lateral view of the pump device having the filter device in a partially sectional view according to FIG. 1;

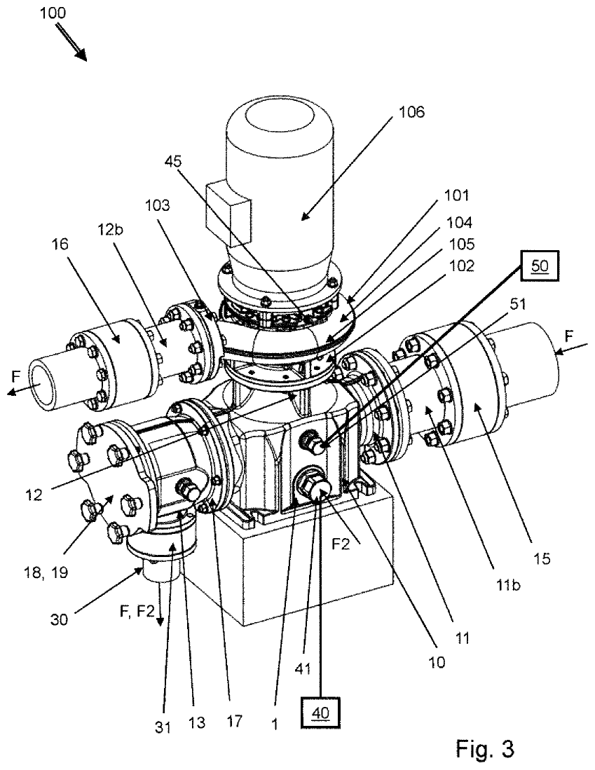

FIG. 3 shows a perspective view of the pump device having the filter device according to FIG. 1 without the partially sectional view;

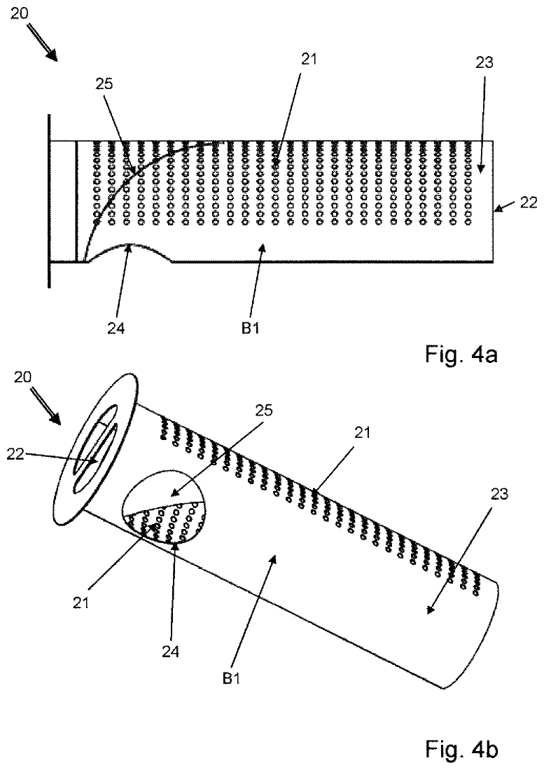

FIG. 4a shows a filter basket in a lateral view; and

FIG. 4b shows a filter basket in a perspective view from obliquely below.

FIG. 1 shows a perspective view of a pump device 100 having a filter device 1 in a partially sectional view in the region of the filter device 1. This pump device 100 is also shown in FIGS. 2 and 3, specifically in a lateral view in FIG. 2 and without the partially sectional view in FIG. 3. Therefore, FIGS. 1, 2 and 3 are conjointly described, and identical reference signs denote identical components.

The pump device 100 possesses a conveying pump 101 having a pump housing 104 in which an impeller 105 (obscured lying in the interior) driven by a drive motor 106 is disposed. The pump housing 104 lies fluidically between a suction line 102 and a pressure line 103 of the conveying pump 101. The conveying pump 101 can optionally have a dry-run protection which automatically deactivates the conveying pump 101 when there is too little liquid fluid F in the conveying pump 101, in particular in the pump housing 104.

The filter device 1 has a filter housing 10 in which a filter basket 20, aligned so as to be geodetically horizontal, having passage holes 21 is disposed. A filter inlet 11 of the filter housing 10 opens into an interior 22 of the filter basket 20, and a filter outlet 12 of the filter housing 10 leads away from an outside 23 of the filter basket 20. In possible design embodiments, the filter basket 20 is shown once again as an individual part in FIGS. 4a and 4b. An electrically actuated inlet shut-off unit 15 is disposed in the filter inlet 11, or the inlet line 11b connected thereto. Moreover, an electrically actuated outlet shut-off unit 16 is disposed in the filter outlet 12, or an outlet line 12b connected thereto.

The filter basket 20 is configured to be open on both sides, in particular to be elongate and cylindrical, is composed of stainless steel, and possesses a discharge opening 24 which is aligned so as to be geodetically downward and opens into a co-aligned and adjacently disposed discharge opening 13 of the filter housing 10. The interior 22 of the filter basket 20 herein is fluidically connected to a discharge line 30 by way of these discharge openings 13, 24. The discharge opening 13, the filter inlet 11 and the filter outlet 12 are in each case formed by a separate opening in the filter housing 10. The filter inlet 11 and the discharge openings 13, 14 are disposed at mutually opposite end regions of the filter basket 20. The filter basket 20 does not have any passage holes 21 in a region B1 disposed geodetically at the bottom. Said passage holes 21 lie in the region of the filter basket 20 disposed thereabove.

The filter housing 10 is partially formed by an attachment housing 17, wherein the discharge opening 13 of the filter housing 10 is formed in the attachment housing 17. The attachment housing 17 is able to be established in a plurality of angular positions in such a manner that the discharge opening 13 does not necessarily have to point geodetically downward, as shown, but instead can also be aligned so as to point sideways by reassembling.

Furthermore, the filter housing 10 has a filter cover 19 through which the filter basket 20 is removable. The latter is presently disposed in particular on the attachment housing 17. The filter cover 19 simultaneously forms an inspection glass 18 by way of which a view into the interior 22 of the filter basket 20 is possible. The filter inlet 11 opens into the interior 22 of the filter basket 20 on a side of the latter that lies opposite the filter cover 19, or the inspection glass 18, respectively. The filter basket 20 here extends in a tubular manner between the filter cover 19, or the inspection glass 18, respectively, and the filter inlet 11.

The filter basket 20 of the filter device 1 is disposed in the suction line 102 of the conveying pump 101, as a result of which the filter device 1 forms a pump preliminary filter in terms of the conveying pump 101. The filter inlet 11 of the filter device 1 is disposed so as to be fluidically more remote from the conveying pump 101 than the filter outlet 12. As can be seen, the filter housing 10 is directly contiguous to the pump housing 104 of the conveying pump 101. In theory it is possible, but not illustrated in such a way, to utilize housing parts which are quasi part of the filter housing 10 and part of the pump housing 104.

Geodetically at the bottom, the discharge line 30 adjoins the discharge opening 13 of the filter housing 10. An electrically actuated discharge shut-off unit 31 is disposed in the discharge line 30, so that a fluid F, F2 is able to be discharged from the interior 22 of the filter basket 20 by way of the discharge line 30 by activating the discharge shut-off unit 31.

A fluid F from the filter housing 10 can be forced into the filter inlet 11 and/or the filter outlet 12 and/or the discharge line 30 by means of the injection apparatus schematically added in FIG. 3, for example a compressor having a connecting line, and an injection opening 41 opening into the filter housing 10 by injecting an injection fluid F2, depending on which one of the shut-off devices 15, 16, 31 are blocked or opened. The injection opening 41 in the exemplary embodiment is fluidically disposed between the passage holes 21 of the filter basket 20 and the filter outlet 12.

Fluid F, F2 which is discharged from the interior 22 by way of the discharge shut-off unit 31 can in particular flow from the filter inlet 11 through the interior 22 of the filter basket 20 without passing through the passage holes 21, and/or flow from the filter outlet 12 through the passage holes 21 into the interior 22 and from there to the discharge line 30, and/or be the any other fluid directed into the filter housing 10, or injection fluid F2, respectively.

Furthermore, the injection apparatus 40 can be actuated in such a manner that fluid F is first forced from the filter housing 10 into the filter inlet 11 and/or the filter outlet 12, preferably into the filter inlet 11, by injecting the injection fluid F2 before the discharge shut-off unit 31 is opened.

Moreover, the filter device 1 possesses a ventilating apparatus 45 in the filter outlet 12, which is presently disposed on the pump housing 104 and by which air and/or an injection fluid F2 is able to be discharged from the filter housing 10 and the filter outlet 12 including the pump housing 104.

As can be seen in FIGS. 4a and 4b, a directing element 25 which steers fluid F, F2 and/or contaminants in the direction of the discharge opening 24 can optionally be disposed in the filter basket 20.

According to FIG. 3, the filter device 1 moreover possesses a measuring installation 50 comprising a pressure sensor 51 for measuring a pressure within the filter housing 10, and comprising a processor with an algorithm by way of which the degree of contamination of the filter basket 20 is concluded based on the measured pressure. For this purpose, the negative pressure caused by the conveying pump 101 fluidically between the passage holes 21 and the impeller 105 can be determined, for example. The negative pressure prevailing in the interior 22 of the filter basket 10 can also be an indicator for the degree of contamination. A measurement of the pressure differential between the interior 22 and the outside 23 of the filter basket 20 is particularly suitable.

The pump device 100 can henceforth be designed so that a filter cleaning algorithm of a control unit is designed in such a manner that, for carrying out filter cleaning, the control unit

first performs an interruption of operation in that said control unit
a. deactivates the conveying pump 101, or the drive motor 106;
b. closes the outlet shut-off unit 16; and
c. closes the inlet shut-off unit 15;
   thereafter a discharge of contamination takes place in that the control unit
d. opens the discharge shut-off unit 31;
e. activates the injection apparatus 40 for injecting, and/or opens the outlet shut-off unit 16 and/or opens the inlet shut-off unit 15;
   thereafter
f. closes the discharge shut-off unit 31;
   thereafter operation is resumed in that the control unit
g. opens the outlet shut-off unit 16;
h. opens the inlet shut-off unit 15; and
i. re-activates the conveying pump 101.

When the operation is interrupted, the closing of the outlet shut-off unit 16 preferably takes place first, then the de-activation of the conveying pump 101, or of the drive motor 106, and only then the closing of the inlet shut-off unit 15.

When resuming operation, the opening of the inlet shut-off unit 15 preferably takes place first, then the activation of the conveying pump 101, or of the drive motor 106, and only then the opening of the outlet shut-off unit 16.

When discharging contamination, the fluid F, F2 which is discharged from the interior 22 by way of the discharge shut-off unit 31, can flow proportionally from the filter inlet 11 through the interior 22 of the filter basket 20 without passing through the passage holes 21, and flow proportionally from the filter outlet 12 through the passage holes 21 into the interior 22 and from there to the discharge line 30, and proportionally be injection fluid F2 which is injected into the filter housing 10 by the injection apparatus 40.

Furthermore, when the operation is interrupted, the control unit can activate the injection apparatus 40 for injecting, and simultaneously open the outlet shut-off unit 16 and/or the inlet shut-off unit 15, preferably only the inlet shut-off unit 15, at least partially in such a manner that fluid F is forced from the filter housing 10 into the filter inlet 11 and/or the filter outlet 12 by injecting injection fluid F2.

When resuming operation, the ventilating apparatus 45 should first be activated until the filter housing 10 is at least substantially filled with fluid F, before the control unit re-activates the conveying pump 101. In the process, the inlet shut-off unit 15 is preferably opened in order to fill the filter housing 10 from the direction of the filter inlet 11 during ventilating. The outlet shut-off unit 16 remains blocked for the duration, and the conveying pump 101, or the drive motor 106, is deactivated for the duration.

When a defined degree of contamination is detected, the control unit can start the filter cleaning algorithm by means of the measuring installation 50 and a processor with an algorithm by way of which the degree of contamination of the filter basket 20 is concluded based on the measured pressure.

The invention is not limited to any of the embodiments described above but may be modified in many ways.

Instead of injecting injection fluid F2, simple reverse purging with the fluid F per se is also possible, in particular from the direction of the filter inlet 11 as well as from the direction of the filter outlet 12.

All of the features and advantages derived from the claims, the description and the drawing, including structural details, spatial arrangements and method steps, can be essential to the invention individually as well as in the most varied combinations.

List of reference signs

| | |
|---|---|
| 1 | Filter device |
| 10 | Filter housing |
| 11 | Filter inlet |
| 11b | Inlet line |
| 12 | Filter outlet |
| 12b | Outlet line |
| 13 | Outlet opening (filter housing) |
| 15 | Inlet shut-off unit |
| 16 | Outlet shut-off unit |
| 17 | Attachment housing |
| 18 | Inspection glass |
| 19 | Filter cover |
| 20 | Filter basket |
| 21 | Passage holes |
| 22 | Interior |
| 23 | Outside |
| 24 | Discharge opening (filter basket) |
| 25 | Directing element |
| 30 | Discharge line |
| 31 | Discharge shut-off unit |
| 40 | Injection apparatus |
| 41 | Injection opening |
| 45 | Ventilating apparatus |
| 50 | Measuring apparatus |
| 51 | Pressure sensor |
| 100 | Pump device |
| 101 | Conveying pump |
| 102 | Suction line |
| 103 | Pressure line |
| 104 | Pump housing |
| 105 | Impeller |
| 106 | Drive motor |
| B1 | Region (filter basket) disposed geodetically at the bottom |
| F | Fluid |
| F2 | Injection fluid |

1. A filter device (1) having a filter housing (10) in which is disposed a filter basket (20) having passage holes (21),
wherein a filter inlet (11) of the filter housing (10) opens into an interior (22) of the filter basket (20), and a filter outlet (12) of the filter housing (10) leads away from an outside (23) of the filter basket (20),
wherein the filter basket (20) has a discharge opening (24) which opens into a discharge opening (13) of the filter housing (10),
wherein the interior (22) of the filter basket (20), by way of these discharge openings (13, 24), is fluidically connected to a discharge line (30),
wherein a discharge shut-off unit (31) is disposed in the discharge line (30) in such a way that a fluid (F) is able to be discharged from the interior (22) of the filter basket (20) by way of the discharge line (30) by activating the discharge shut-off unit (31), characterized in that
the filter basket (20) is aligned so as to be geodetically horizontal and in a region (B1), disposed geodetically at the bottom, does not have any passage holes (21); and/or
the discharge opening (24) of the filter basket (20) is a hole in a circumferential wall of the filter basket (20).

2. The filter device (1) as claimed in claim 1, characterized in that the filter inlet (11) and the discharge openings (13, 14) are disposed on mutually opposite end regions of the filter basket (20).

3. The filter device (1) as claimed in claim 1, characterized in that the discharge opening (24) of the filter basket (20) is formed in the region (B1), disposed geodetically at the bottom, of the filter basket (20).

4. (canceled)

5. (canceled)

6. The filter device (1) as claimed in claim 1, characterized in that the discharge openings (13, 24) are aligned so as to be geodetically downward.

7. The filter device (1) as claimed in claim 1, characterized in that a directing element (25) which steers fluid (F) and/or contaminants in the direction of the discharge opening (24) is disposed in the filter basket (20).

8. (canceled)

9. The filter device (1) as claimed in claim 1, characterized in that an inlet shut-off unit (15) is disposed in the filter inlet (11) or an inlet line (11b) connected thereto.

10. The filter device (1) as claimed in claim 1, characterized in that an outlet shut-off unit (16) is disposed in the filter outlet (12) or an outlet line (12b) connected thereto.

11. The filter device (1) as claimed in claim 1, characterized in that the fluid (F), which is discharged from the interior (22) by way of the discharge shut-off unit (31),
flows from the filter inlet (11) through the interior (22) of the filter basket (20) without passing through the passage holes (21), and/or
flows from the filter outlet (12) through the passage holes (21) into the interior (22) and from there to the discharge line (30), and/or
is any other fluid (F, F2) which has been directed into the filter housing (10).

12. The filter device (1) as claimed in claim 1, characterized in that an injection apparatus (40) opens into the filter housing (10) by way of an injection opening (41), a fluid (F) being able to be forced from the filter housing (10) into the filter inlet (11) and/or the filter outlet (12) and/or the discharge line (30) by injecting an injection fluid (F2) by way of said injection opening (41).

13. (canceled)

14. (canceled)

15. (canceled)

16. (canceled)

17. The filter device (1) as claimed in claim 1, characterized in that said filter device (1) has a ventilating apparatus (45) by which air and/or an injection fluid (F2) are/is able to be discharged from the filter housing (10).

18. (canceled)

19. The filter device (1) as claimed in claim 1, characterized in that the filter housing (10) is partially formed by an attachment housing (17), wherein the discharge opening (13) of the filter housing (10) is formed in the attachment housing (17).

20. (canceled)

21. (canceled)

22. The filter device (1) as claimed in claim 1, characterized in that the filter housing (10) has a filter cover (19) through which the filter basket (20) is removable.

23. The filter device (1) as claimed in claim 22, characterized in that the filter inlet (11) opens into the interior (22) of the filter basket (20) on a side of the latter that lies opposite the filter cover (18).

24. The filter device (1) as claimed in claim 22, characterized in that the filter basket (20) extends in a tubular manner between the filter cover (19) and the filter inlet (11).

25. The filter device (1) as claimed in claim 1, characterized in that the filter basket (20) is configured to be open on both sides, in particular elongate and/or cylindrical.

26. (canceled)

27. (canceled)

28. A pump device (100) having a conveying pump (101) which is disposed between a suction line (102) and a pressure line (103), and having a filter device (1) as claimed in claim 1, wherein the filter basket (20) of the filter device (1) is disposed in the suction line (102).

29-45. (canceled)
